(19) United States
(12) Patent Application Publication
(10) Pub. No.: US 2017/0156825 A1
(43) Pub. Date: Jun. 8, 2017

(54) OVAL PLATFORM DENTAL IMPLANT SYSTEM (OPI)

(71) Applicant: Reza RAHGOZAR, Vancouver (CA)

(72) Inventor: Reza RAHGOZAR, Vancouver (CA)

(21) Appl. No.: 15/439,130

(22) Filed: Feb. 22, 2017

Related U.S. Application Data
(63) Continuation-in-part of application No. 14/397,609, filed on Mar. 18, 2015.

(51) Int. Cl. A61C 8/00

(52) U.S. Cl. CPC A61C 8/0078; A61C 8/0009; A61C 8/006; A61C 8/0072

(57) ABSTRACT

The “OPI” dental implant may include a body and an attachment member. The body may include an implant core portion and an extension portion. The implant core portion may extend from a first surface of the body to a second surface of the body at a first tapered angle. The extension portion/s may extend from the first surface of the body to the third and fourth surface of the body at a second and third tapered angle. The attachment member may be attached to the first surface of the body and configured to attach a prosthetic to the body.

### CROSS-REFERENCE TO RELATED APPLICATIONS

This application is a continuation-in-part of U.S. patent application Ser. No. 14/397,609 filed on Mar. 18, 2015, which is a National Stage of International Application No. PCT/CA2012/050280, filed on May 2, 2012. The entire disclosures of each of the above applications are incorporated herein by reference.

### FIELD

The present disclosure relates to a dental implant system.

### BACKGROUND

This section provides background information related to the present disclosure which is not necessarily prior art.

Conventional dental implant systems include dental implants and techniques for installing dental implants in a jawbone. Commonly used conventional dental implant systems employ cylindrical implants which have limitations in replacing the missing tooth/teeth. For example, using a shorter and/or smaller diameter size implant in an implant site having inadequate bone will cause implant failure due to overloading the implant under chewing forces. Therefore the conventional dental implant systems are not easily adaptable to varying implant sites without jeopardizing the implant success.

### SUMMARY

The proposed dental implant system and installation technique provides convenient and accurate preparation of the implant site for a new generation of dental implants, hereafter referenced as “oval platform implant(s) or “OPI ” which can be easily adapted to the available bone at the varying implant sites of the patient's jawbone. The adaptability of the “OPI” to the available bone and its unique characteristics dramatically reduces the need for bone graft procedures and its associated risks, cost and overall treatment time, while increasing the implant-bone interface which is critical in occlusal load bearing of the implant and its long term success.

This section provides a general summary of the disclosure of Oval Platform Dental Implant “OPI system”, and is not a comprehensive disclosure of its full scope or all of its features and benefits.

The “OPI” includes a body and an attachment member. The body includes a core portion and an extension portion which are connected. Together, they form an oval shape platform or first surface of the implant body. The attachment member/members are connected to the first surface of the implant body or the platform and is/are configured to attach a prosthetic to the implant body.

In one form, of the “OPI” dental implant, the implant core portion which has circular or round cross section extends from the first surface of the body to the second surface of the body which is also circular or round at a first tapered angle. The extension portion, which completes the oval shape of the first surface of the implant body, otherwise described as the platform herein, extends from the first surface of the body to the second surface of the body at a second tapered angle.

In some configurations, the attachment member/members extend outwardly from the first surface of the body.

In some configurations, the attachment member/members extend inwardly toward the second surface from the first surface of the body.

In some configurations, a plurality of apertures extends through the body of the dental implant.

In some configurations, the first tapered angle and the second tapered angle are the same.

In some configurations, the first tapered angle and the second tapered angle are different.

In some configurations, the attachment member is configured to attach to the prosthetic via an abutment.

In another form of “OPI”, the body includes an implant core portion and a first extension portion. The implant core portion which could be either circular or oval extends from the first surface of the body to the second surface of the body which will be either circular or oval. The first extension portion which completes the oval platform (first surface) of the implant body extends from the first surface of the body toward the third surface of the body. The second surface and the third surface have a first distance between each other (d). The attachment member/members attaches to the first surface of the body and are configured to attach a prosthetic to the body.

In the above configurations of the “OPI” with implant core and one extension in the implant body, the implant core portion extends from the first surface of the body to the second surface of the body at a first tapered angle and the first extension portion extends from the first surface of the body to the third surface of the body at a second tapered angle.

In some configurations, the first tapered angle and the second tapered angle are the same.

In some configurations, the first tapered angle and the second tapered angle are different.

In yet another configuration, the dental implant body includes two extension portions attached to two opposite sides of the implant core portion. As previously discussed, the implant core portion, which could have either circular or oval cross section, extends from the first implant body surface to the second surface at the first tapered angel. The first extension portion extends from the first surface of the implant body toward the third surface at the second tapered angle. The second extension portion extends from the first surface of the implant body toward the fourth surface at the third tapered angle. The second surface and the third surface have the first distance between each other (d1). The second surface and the fourth surface have the second distance between each other (d2).

In some configurations, the first distance (d1) and the second distance (d2) are the same.

In some configurations, the first distance (d1) and the second distance (d2) are different.

In some configurations, the first, second and third tapered angels between the first surface of the implant body and second, third and fourth surface are essentially the same.

In some configurations, the first, second and third tapered angels between the first surface of the implant body and second, third and fourth surfaces are different from each other.

The present disclosure provides a method of forming a cavity in a jawbone to install the “OPI” dental implant therein. The method includes forming an initial core of the cavity in the jawbone with the first drill; positioning the seat portion of the surgical guide on the jawbone such that an alignment member of the surgical guide extends into the initial core of the cavity; inserting the second drill through the first end of the opening in the seat portion of the surgical guide such that the cutting portion of the second drill extends through the first end of the opening of the surgical guide and into the initial core of the cavity; and creating the extension portion while traversing the second drill from the first end of the opening to the second end of the opening of the surgical guide to remove a portion of the jawbone and form the first extension to the core of the cavity.

In another configuration, the method includes removing the surgical guide from the jawbone and rotating the surgical guide 180 degrees to be repositioned on the jawbone. This method includes repositioning the seat portion of the surgical guide on the jawbone such that the alignment member extends into the initial core cavity from the opposite direction.

In the above configurations, the method includes reinserting the second drill through the first end of the opening in the surgical guide and traversing the second drill from the first end of the opening to the second end of the opening to remove another portion of the jawbone and form a second extension to the core of the cavity.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a first drill of the “OPI” dental implant system according to the principles of the present disclosure;

FIG. 2 is a front view of a second drill of the “OPI” dental implant system of FIG. 6;

FIG. 3 is a perspective view of a surgical guide of the “OPI” dental implant system of FIG. 6;

FIG. 4 is another perspective view of the surgical guide of the “OPI” dental implant system of FIG. 6;

FIG. 5 is a top view of the surgical guide of the “OPI” dental implant system of FIG. 6;

FIG. 6 is a perspective view of one variation of the “OPI” dental implant system;

FIG. 7 is a top view of the dental implant of FIG. 6;

FIG. 8 is a front view of an abutment of the “OPI” dental implant system;

FIG. 8a is a front view of an abutment with a recess for receiving the attachment member of FIG. 13;

FIG. 8b is a front view of an abutment with a male member to be inserted into the recess of the implant shown in FIG. 12;

FIG. 9 is a front view of the abutment and the dental implant coupled to each other;

FIG. 10 is a side view of the abutment and the dental implant coupled to each other;

FIG. 11 is a perspective view of an alternate dental implant of the “OPI” dental implant system of FIG. 6;

FIG. 12 is a perspective view of yet another alternate dental implant of the “OPI” dental implant system of FIG. 6 ;

FIG. 13 is a perspective view of yet another alternate dental implant of the “OPI” dental implant system of FIG. 6 ;

FIG. 14 is a side view of the alternate dental implant shown in FIG. 13;

FIG. 15 is a cross-sectional view of a portion of the alternate “OPI” dental implant taken along line 15-15 of FIG. 14;

FIG. 16 is a cross-sectional view of the method of the procedure for the “OPI” dental implant system (FIGS. 6, 7, and 11-14) showing the first drill forming an initial core of a cavity in a jawbone;

FIG. 17 is a cross-sectional view of the method of the procedure for the “OPI” dental implant system (FIGS. 6, 7, and 11-14) showing the second drill being inserted into the initial core formed in the jawbone;

FIG. 18 is a cross-sectional view of the method of the procedure for the “OPI” dental implant system (FIGS. 6, 7, and 11-14) showing the second drill traversing an opening in the surgical guide to form an extension to the core of the cavity;

FIG. 19 is a cross-sectional view of the cavity formed in the jawbone by the first drill of FIG. 1, the second drill of FIG. 2, and the surgical guide of FIG. 3;

FIG. 20 is a cross-sectional view of the dental implant system (FIGS. 6, 7, and 11-14) for example, showing the dental implant of FIG. 6 installed in the cavity formed in the jawbone;

FIG. 21 is a front view of the second drill of an alternate “OPI” dental implant system according to the principles of the present disclosure;

FIG. 22 is a perspective view of a surgical guide of the “OPI” dental implant system of FIGS. 25 to 29 and FIGS. 35 to 38; for example,

FIG. 23 is a front view of the surgical guide of the “OPI” dental implant system of FIGS. 25 to 29 and FIGS. 35 to 38, for example;

FIG. 24 is a top view of the surgical guide of the dental implant system of FIGS. 25 to 29 and FIGS. 35 to 38;

FIG. 25 is a perspective view of a dental implant of the “OPI” dental implant system of FIGS. 26 and 27;

FIG. 26 is a front view of the dental implant of the dental implant system of FIGS. 25 and 27;

FIG. 27 is a side view of the dental implant of FIGS. 25 and 26;

FIG. 28 is a side view of yet another alternate dental implant of the “OPI” dental implant system of FIG. 25;

FIG. 29 is a perspective view of an alternate dental implant of the “OPI” dental implant system of FIGS. 25 and 28;

FIG. 30 is a cross-sectional view of the method of the procedure for “OPI” dental implant system of FIGS. 25 to 29 for example, showing the first drill FIG. 1 forming an initial core of a cavity in a jawbone;

FIG. 31 is a cross-sectional front view of the “OPI” dental implant system of FIGS. 25 to 29 for example, showing the surgical guide of FIG. 23 inserted into the initial core cavity formed in FIG. 30 and the second drill being inserted into the initial core formed in the jawbone;

FIG. 32 is a cross-sectional view of the “OPI” dental implant system of FIGS. 25 to 29 for example, showing the second drill traversing an opening formed in the surgical guide of FIG. 23 to form an extension to the core of the cavity;

FIG. 33 is a cross-sectional view of the cavity formed in the jawbone by the first drill of FIG. 1, the second drill of FIG. 21, and the surgical guide of FIG. 23;

FIG. 34 is a cross-sectional view of the “OPI” dental implant system of FIGS. 25 to 28 for example, the dental implant in FIG. 25 installed in the cavity formed in the jawbone;

FIG. 35 is a perspective view of yet another alternate dental implant of the “OPI” dental implant system of FIGS. 25 to 29 for example;

FIG. 36 is a front view of the alternate dental implant of FIG. 32;

FIG. 37 is a side view of the dental implant of FIG. 36;

FIG. 38 is side view of the alternate dental implant of FIG. 37;

FIG. 39 is a cross-sectional view of the method of the procedure for the “OPI” dental implant system of FIGS. 35 to 38, for example, showing the first drill FIG. 1 forming an initial core of a cavity in a jawbone;

FIG. 40 is a cross-sectional view of the method of the procedure for the “OPI” dental implant system of FIGS. 35 to 38, for example, showing surgical guide of FIG. 23 inserted into the initial core cavity formed in FIG. 39 and the second drill FIG. 21 being inserted into the initial core formed in the jawbone;

FIG. 41 is a cross-sectional view of the method of the procedure for the “OPI” dental implant system of FIGS. 35 to 38, for example, showing the second drill traversing the opening formed in the surgical guide of FIG. 23 to form the first extension to the core of the cavity;

FIG. 42 is a cross-sectional view of the method of the procedure for the “OPI” dental implant system of FIGS. 35 to 38, for example, showing the second drill traversing the opening formed in the surgical guide to form the second extension to the core of the cavity;

FIG. 43 is a cross-sectional front view of the cavity formed in the jawbone by the first drill of FIG. 1, the second drill of FIG. 21, and the surgical guide of FIG. 23;

FIG. 44 is a cross-sectional front view of the dental implant system of FIGS. 35 to 38, for example, showing the “OPI” dental implant of FIG. 36 installed in the cavity formed in the jawbone.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The types of oval platform implants “OPI” corresponds to the height and number of the extension portions in relation to the implant core section in an implant body. For example as the expression is used herein, the Type 1 “OPI” refers to a group of the implants where the core section and extension section have essentially the same height, see FIGS. 6, 7, and to 11-14, for example.

The type 2 “OPI” refers to a group of implants having an extension on one side of the implant core, see FIGS. 25 to 29, for example.

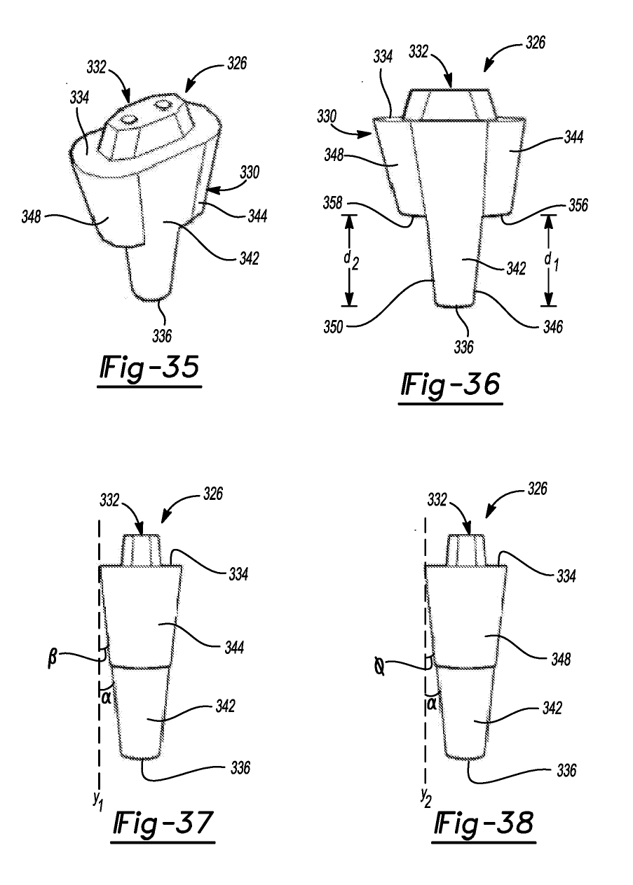

The type 3 “OPI” refers to a group of implants which have two extensions in two opposite sides of the implant core, see FIGS. 35 to 38, for example.

The different types of OPI offered under the present invention (Types I, II, Ill) are intended to offer flexibility to the dental practitioner while still offering the various benefits provided by the OPI's disclosed herein. Such situations include being too close to the maxillary sinus or mental nerve or root of the adjacent tooth without doing bone graft or sinus augmentation surgery or orthodontic treatment to upright the adjacent tooth.

By way of non-limiting example, situations are noted below wherein the different OPI's would be highly preferred.

Type I OPI's can be used in situations when there is no anatomical obstruction like tilted root of the adjacent tooth or anatomical limit like maxillary sinus or lower mental nerve.

Type II OPI's are used when there is an anatomical obstruction like tilted root of the adjacent tooth or anatomical limit like maxillary sinus or lower mental nerve in one side of the implant site. As should be understood by dental practitioners, the area occurring below or to the side of the implant body where the OPI is truncated as compared to the rest of the body is the area where the obstruction is present.

Type III OPI's are used when there are anatomical obstruction like tilted root of the adjacent tooth or anatomical limit like maxillary sinus or lower mental nerve on both sides of the implant site for example on upper premolars area when the implant site is limited by anterior wall of the maxillary sinus at the back and tilted root of the adjacent root on the front of the implant site. Again, it is the area occurring below and/or to the sides of the implant body that appears truncated that accommodates the obstruction.

Regardless of the implant embodiments described therein, the Type I, II and III implants have a wider implant structure (generally 3.75 mm to 12 mm) and a wider platform as compared to conventional implants. Additionally, the implants are thicker (3.75 mm to 6 mm generally) than of the known implants.

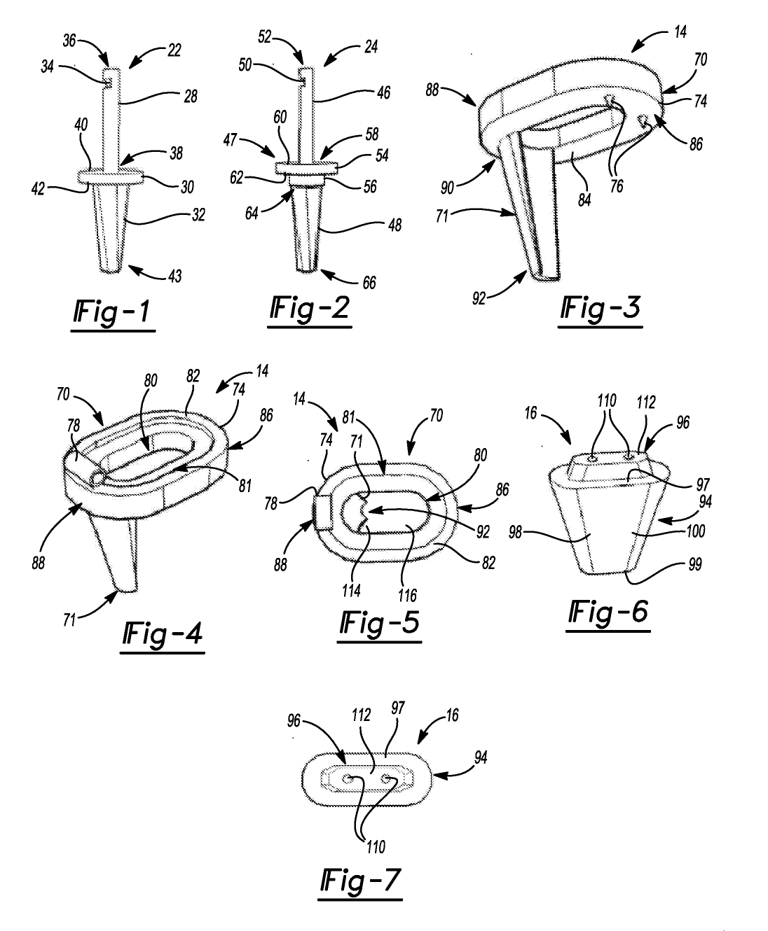

With reference to FIGS. 6-14, Type 1 oval dental implant systems are shown. The above group of dental implant may be implanted into the jawbone of a patient after preparing an implantation site utilizing a drill assembly including a first drill 22 (FIG. 1), a second drill 24 (FIG. 2), and a surgical guide 14 (FIG. 3). As will be described in more detail below, the drill assembly (composed of the first drill 22 and the second drill 24), and the surgical guide 14 cooperate to form a cavity 18 (FIG. 19) in a jawbone 20 of a patient (not shown) so that the dental implant 16 will be conveniently inserted therein.

The first drill 22 operates to form an initial core 26 in the jawbone 20. As shown in FIG. 1, the first drill 22, like standard surgical drills used in implant surgeries includes a shaft 28 with a latch 34, and a conical drilling portion 32. In addition to the standard surgical drills, the OPI drill assembly has an annular flange 30 which works as a stopper. A latch 34 at a first end 36 of the shaft 28 locks the first drill 22 to a surgical hand-piece (not shown), which is connected to an electric motor (not shown) for rotating the first drill 22. In some configurations, the end 43 of the drilling portion 32 may have a dome or torpedo-shaped surface such that the bottom surface 45 of the initial core 26 has a corresponding dome or torpedo-shaped surface once the first drill 22 forms the initial core 26.

The second drill 24 operates to form an extension 44 to the core of the cavity 18 in the jawbone 20. As shown in FIG. 2, the second drill 24 includes a shaft 46, a guide member 47, and a conical drilling portion 48. A latch 50 locks the second drill 24 to a surgical hand-piece (not shown), which is connected to an electric motor (not shown) for rotating the second drill 24. The guide member 47 is disposed at a second end 58 of the shaft 46 and includes a circular flange 54, which works as a stopper and guide, and a cylindrical extension member 56. The circular flange 54 may be disposed on the shaft 46 and extend radially outward therefrom. The flange 54 may have a top surface 60 and a bottom surface 62 opposing the top surface 60. The extension member 56 extends from the bottom surface 62 of the flange 54 and is positioned between the flange 54 and the drilling portion 48.

The drilling portion 48 may have the same conical shape and length as the drill portion 32 of the first dill 22 (i.e., tapered equally) and may extend longitudinally, relative to the shaft 46, from the extension member 56. In some configurations, the conical shape may be different than the conical shape of the drill portion 32 of the first drill 22 thereby forming extension core having a different tapered angle from the initial core. A first end 64 of the drilling portion 48 may have a diameter generally equal to that of the extension member 56 and a second end 66 of the drilling portion 48 may have a diameter less than that of the extension member 56. The second end 66 of the drilling portion 48 may have a flat circular-shaped surface such that a bottom surface 68 of the extension core 44 has a corresponding flat-circular-shape once the second drill 24 forms the extension core 44. In some configurations, the second end 66 of the drilling portion 48 may have a dome or torpedo-shaped surface such that the bottom surface 68 of the extension core 44 has a corresponding dome or torpedo-shaped surface once the second drill 24 forms the extension core 44. This may allow for a more convenient installation of the another alternative shape of dental implant 16 with a more exaggerated conical end (not shown) into the cavity 18 formed in the jawbone 20.

The surgical guide 14 may be made of a stainless steel material, certain rigid plastics or combinations thereof and include a seat portion 70 and an arcuate alignment member 71. The seat portion 70 may be positioned on a top surface 72 of the jawbone 20 (FIGS. 17 and 18) and may include a substantially oval-shaped body 74, a plurality of gripping elements 76, and a tubular member 78. The body 74 may have a thickness substantially equal to a thickness of the guide member 47 of the second drill 24 and may define an oval-shaped opening 80 (FIGS. 3-5) extending there through and an oval-shaped recess 81 (FIGS. 4 and 5) at or near the top surface 82 of the body 74. The oval-shaped opening 80 and the oval-shaped recess 81 may be concentric to each other.

As shown in FIG. 3, the plurality of gripping elements 76 may be positioned near or at a first end 86 of the body 74 and may extend perpendicularly from a bottom surface 84 of the body 74. As shown in FIGS. 4 and 5, the tubular member 78 may be positioned near or at a second end 88 of the body 74 and may extend along the top surface 82 of the body 74. The oval-shaped opening 80 in the body 74 may be situated between the plurality of gripping elements 76 and the tubular member 78.

The alignment member 71 of the surgical guide 14 may extend at least substantially perpendicularly from the bottom surface 84 of the body 74 (FIGS. 3 and 4). The alignment member 71 may have a first end 90 that extends around a periphery of the opening 80 at the second end 88 of the body 74 (FIG. 3). The alignment member 71 may be tapered such that a second end 92 extends into the opening 80 of the body 74 (FIG. 5). The alignment member 71 may be tapered equally to the initial core 26 formed by the first drill 22.

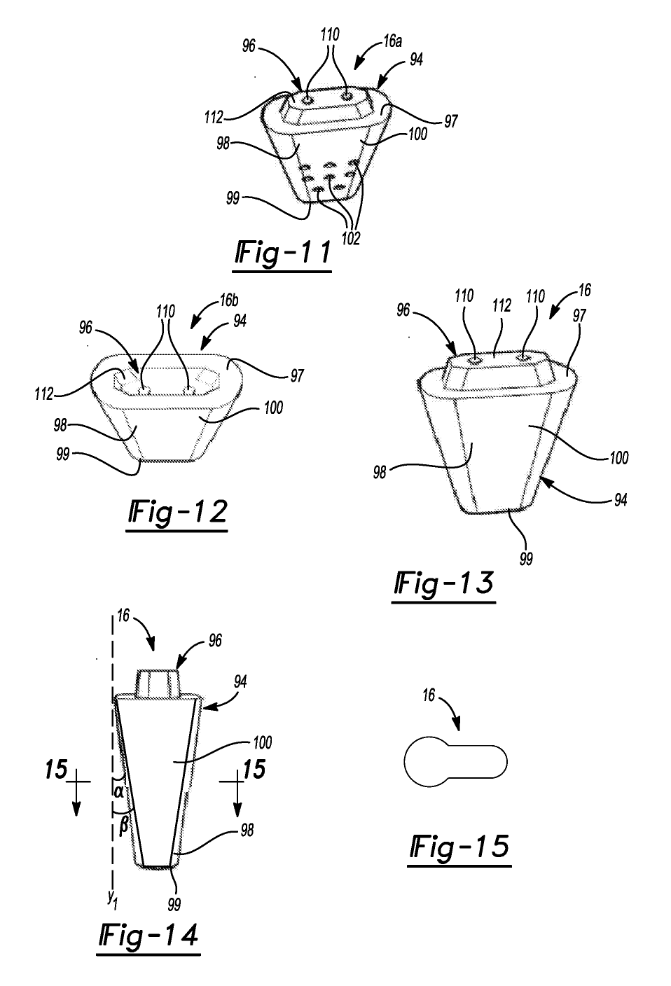

The dental implant 16 may be made out of a titanium alloy and/or covered with hydroxyl apatite or other biocompatible bone inducing material, for example, and may be installed into the cavity 18 formed by the drill assembly (composed of first drill 22 and second drill 24) and surgical guide 14. The dental implant 16 may include a body 94 and an attachment member/members or interlocking member 96 (FIGS. 6 and 7). The body 94 of the dental implant 16 may have a flat oval-shaped first surface or platform 97 and a flat generally oval-shaped second surface 99. In some configurations, the second surface 99 may be a dome or torpedo-shape to facilitate installation of the dental implant 16 in the cavity 18 having a correspondingly dome shaped bottom surface, as described above. The body 94 may include an implant core portion 98 and an extension portion 100. In some configurations, the body 94 of a dental implant 16 may also include a plurality of apertures 102 extending there through (FIG. 11). The plurality of apertures 102 may be filled with a hydroxyapatite and/or bone inducing or osteoconductive material to promote bone growth inside and between the dental implant 16 and the jawbone 20. In some configurations, a surface of the body 94 may include a roughness to increase the surface of the implant 16 in contact with the jaw bone 20 and to facilitate or promote bone growth between the dental implant l6 and the jawbone 20. As can be seen with reference to FIGS. 6-14, the body 94 may have a generally elliptoconical shape within certain exemplary tapered walls offering tapered angles as will be described below.

The implant core portion 98 may extend from the flat oval-shaped first surface 97 to the flat oval-shaped second surface 99 at a first tapered angle a relative to a vertical axis Y1. The extension portion 100 may extend from the first surface 97 to the second surface 99 at a second tapered angle β relative to the vertical axis Y1. The first and second tapered angles α, β of the implant core portion 98 and the extension portion 100, respectively, may be equal to each other. In some configurations, the first and second tapered angles α, β may be different from one another (FIGS. 13-15). This provides the advantage of avoiding a bone graft procedure, for example, when the jawbone 20 has varying thicknesses in adjacent areas due to the ability of the implant core portion 98 and/or the extension portion 100 to account for such varying thicknesses.

The attachment member 96 may be a single recess as shown or made of two or more pieces, (not shown), preferably two, with each piece having a fastener member. The attachment member is elongated and preferably has a polygonal shape. A highly preferred shape is an elongated hexagon. The attachment member such as that shown in FIG. 13 is attached to the first surface 97 of the body 94. The attachment member/members 96 are attached to the first surface 97 so as to extend outwardly therefrom. In some configurations, such as that shown in FIG. 12, the attachment member 96 may extend inwardly from the first surface 97 of the body 94 of a dental implant 16b toward the second surface 99. It should be understood that the attachment member 96 may be single or double (not shown) and may also be any other suitable shape (e.g., square, rectangle, pentagonal, hexagonal) that allows for attachment to the first surface 97 of the body 94. The attachment member 96 may, and preferably does, include a plurality of apertures (screw holes) 110 on a surface 112 to allow the abutment 17 to attach thereto via fasteners such as threaded bolts, for example (not shown).

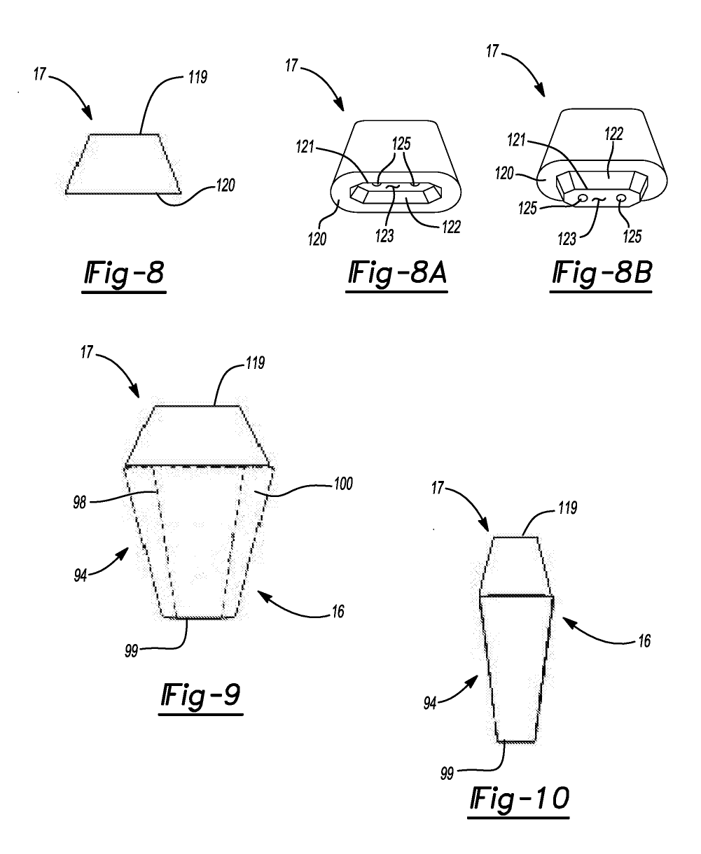

The abutment 17 may include oval-shaped first and second surfaces 119, 120 and an interlocking member. Further, the interlocking member is in the form of a recess 123 shown in FIG. 8a or an extension 124 such as that shown in FIG. 8b depending on the embodiment as will be described in more detail below. The overall shape of the interlocking member is typically, but not exclusively, polygonal or oval. The second surface 120 corresponds to the oval shape platform 97 of the dental implant 16 (FIGS. 8a, 8b, and 9). It should be understood that the first and second surfaces, 119, 120 maybe other suitable shapes, and therefore, the second surface 120 can correspond to the shape of the platform 97 of the dental implant 16. The interlocking member may extend from the second surface 120 and extend inwardly toward the first surface 119 and include a plurality of apertures 125 extending therethrough. In this way, the attachment member 96 may be received in a recess 123 formed in the second surface 120, and the attachment member 96 and the interlocking member may be coupled together via fasteners (not shown) extending through the apertures 125 in the interlocking member and apertures 110 in the attachment member 96. The arrangement is generally depicted with reference to FIGS. 8a and FIG. 13 in combination with attachment member

In embodiments where the attachment member 96 extends inwardly from the first surface 97 towards the second surface 99 (FIG. 12), the interlocking member may be attached to the second surface 120 so as to extend outwardly therefrom as shown in FIG. 8b. In this way, the interlocking member may be received in the cavity formed in the dental implant 16, and attached to the attachment member 96 via fasteners (not shown) extending through the apertures of the interlocking member and apertures 110 of the attachment member 96. This arrangement is generally depicted with reference to FIGS. 8b and FIG. 12, in combination. A prosthetic such as a healing or temporary prosthetic (not shown) may be attached to the dental implant 16 via the abutment 17. The abutments of the present invention are designed specifically to more effectively transmit the rotational forces on the prosthetic (not shown) to the dental implant 16 and the jawbone 20 instead of the fasteners (not shown). The prosthetic (not shown) may be an artificial tooth or teeth, crown, bridges or dentures, by way of non-limiting example, that gives the natural appearance and function of the teeth of the patient. It should be understood that the dental implant 16 and the attachment 96 may constitute a dental implant sub assembly. Likewise, it should be understood that the abutment and prosthetic may constitute a superstructure as the term is known in the art. The combination of the implant substructure assembly and the superstructure assembly may collectively be referred to herein as a dental implant system according to the teachings of the present invention.

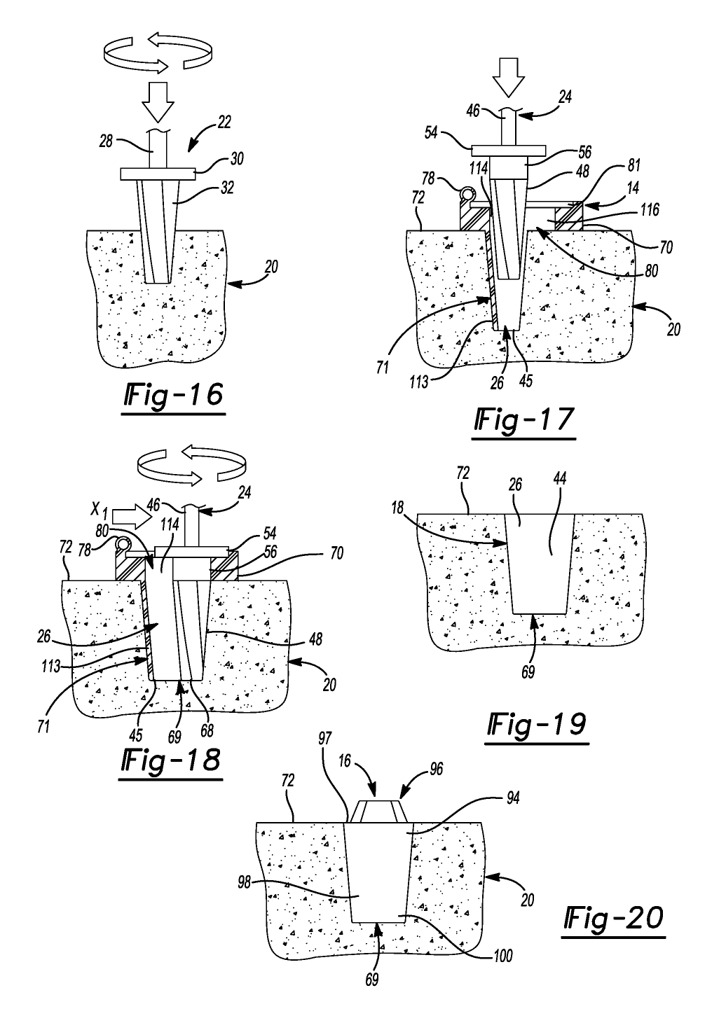

With continued reference to FIGS. 1-20, installation of the dental implant 16 will be described in detail. A user (not shown in FIG. 16) forms the initial core 26 in the jawbone 20 of the patient (not shown) using the first drill 22 (FIG. 1).

The user then positions the seat portion 70 of the surgical guide 14 on the top surface 72 of the jawbone such that the alignment member 71 extends into the initial core 26 formed by the first drill 22 and an outer surface 113 of the alignment member 71 is adjacent to the jawbone 20 (FIGS. 17 and 18). The second drill 24 is inserted through the first end 114 of the opening 80 such that the drilling portion 48 of the second drill 24 extends through the first end 114 of the opening 80 into the initial core 26 and the guide member 47 is substantially co-planar with the body 74 of the seat portion 70. The alignment member 71 facilitates alignment of the drill portion 48 within the initial core 26 and the flange 54 of the guide member 47 is received in the recess 81 of the body 74. The flange 54 traverse the recess 81 of the body 94 as the second drill 24 traverses in direction X1 from the first end 114 of the opening 80 to a second end 116, thereby removing a portion of the jawbone 20 to form the extension 44 to the core of the cavity 18. The gripping elements 76, grip the jawbone 20 to facilitate stability of the surgical guide 14 relative to the jawbone 20 while the second drill 24 is traversing the opening 80. The tubular member 78 extending along the second end 88 of the seat portion 70 further facilitates stability of the surgical guide 14 relative to the jawbone 20 while the second drill 24 is traversing the opening 80.

In some configurations, a third drill (not shown) may be used to refine a bottom surface 69 (composed of bottom surfaces 45 and 68) of the cavity 18 when the jawbone is dense, for example, thereby facilitating installation of the dental implant 16. The outer surface (not shown) of the drilling portion (not shown) of the third drill (not shown) may be polished such that other portions of the jawbone 20 are not removed.

The user then installs the dental implant 16 into the cavity 18 (FIG. 19) such that the implant core portion 98 of the dental implant 16 is disposed in the initial core 26 and the extension portion 100 of the dental implant 16 is disposed in the extension core 44 of the cavity 18. The first surface 97 of the body 94 of the dental implant 16 is substantially co-planar with the top surface 72 of the jawbone once the dental implant 16 is fully inserted into the cavity 18 while the second surface 99 abuts against the bottom surface 69 of the cavity 18 (FIG. 20). It should be understood that the dental implant 16 may include a collar (not shown) extending around a periphery of the first surface 97 toward the second surface 99.

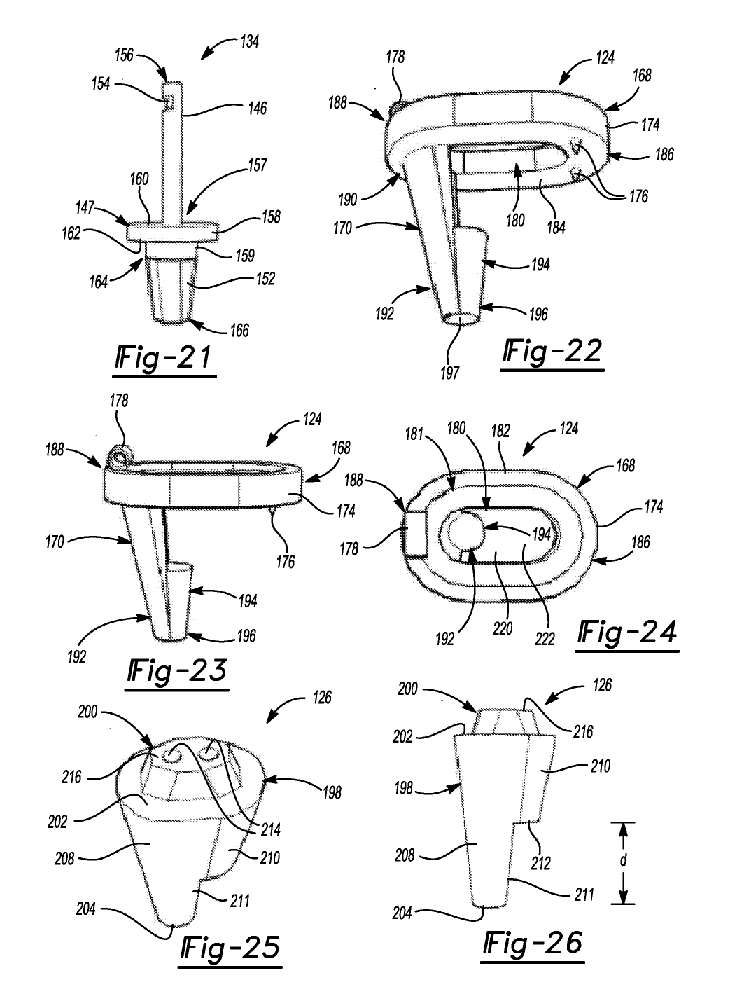

With reference to FIGS. 21-34, another group of “OPI” dental implant system (Type 2) is provided. The structure and function of the another dental implant system may be similar or identical to that of the dental implant system described above, apart from any exceptions described below.

The dental implant system may include a drill assembly (composed of the first drill 22 and a second drill 134), a surgical guide 124, and a dental implant 126, and an abutment such as that shown with reference to FIGS. 8-10, for example. The drill assembly (composed of the first drill 22 and a second drill 134) and the surgical guide 124 cooperate to form a cavity 128 in a jawbone 130 of a patient (not shown) so that the dental implant 126 may be conveniently inserted therein. The drill assembly includes the first drill 22, as described above, and a second drill 134. The first drill 22 operates to form an initial core 132 of the cavity 128. The second drill 134 may operate to form an extension 163 (FIG. 33) to the core of the cavity 128 in the jawbone 130 and may include a shaft 146, a guide member 147 and a conical drilling portion 152. As shown in FIG. 21, a latch 154 at a first end 156 of the shaft 146 locks the second drill 134 to a surgical hand-piece (not shown), which is connected to an electric motor (not shown) for rotating the second drill 134. The guide member 147 may be disposed at a second end 157 of the shaft 146 and include a circular flange 158 and a cylindrical extension member 159. The flange 158 which works as a stopper and guide may extend radially from the shaft 146 and have a top surface 160 and a bottom surface 162 opposing the top surface 160. The extension member 159 which is cylindrical may extend from the bottom surface 162 of the flange 158 and be positioned between the flange 158 and the drilling portion 152.

The drilling portion 152 may have the same conical shape as the drill portion 32 of the first dill 22 (i.e., tapered equally) and a different length than the drill portion 32 of the first drill 22. The drilling portion 152 may extend longitudinally, relative to the shaft 146, from the extension member 159. In some configurations, the conical shape may be different than the conical shape of the drill portion 32 of the first drill 22 thereby forming an extension core having a different tapered angle from the initial core. A first end 164 of the drilling portion 152 may have a diameter generally equal to that of the extension member 159 and a second end 166 of the drilling portion 152 may have a diameter less than that of the extension member 159.

With reference to FIGS. 22-24, the surgical guide 124 may be made out of a stainless steel material and include a seat portion 168 and an arcuate alignment member 170. The seat portion 168 may be positioned on a top surface 172 of the jawbone 130 (FIGS. 31 and 32) and may include an oval-shaped body 174, a plurality of gripping elements 176, and a tubular member 178. The body 174 may have a thickness substantially equal to a thickness of the guide member 147 of the second drill 134 and may define an oval-shaped opening 180 extending there through (FIGS. 22 and 24) and an oval-shaped recess 181 at or near a top surface 182 of the body 174 (FIG. 24). The oval-shaped opening 180 and the oval-shaped recess 181 may be concentric to each other.

The plurality of gripping elements 176 may be positioned near or at the first end 186 of the body 174 and may extend perpendicularly from the bottom surface 184 of the body 174. The tubular member 178 may be positioned near or at a second end 188 of the body 174 and may extend along the top surface 182 of the body 174. The oval-shaped opening 180 in the body 174 may be situated between the plurality of gripping elements 176 and the tubular member 178.

The alignment member 170 of the surgical guide 124 may extend perpendicularly from the bottom surface 184 of the body 174 (FIGS. 22 and 23). The alignment member 170 may have a first end 190 that extends around a periphery of the opening 180 at the second end 188 of the body 174 (FIG. 22). The alignment member 170 may be tapered such that a second end 192 extends into the opening 180 of the body 174 (FIG. 24). The alignment member 170 may be tapered equally to the initial core 132 formed by the first drill 22. A cylindrical seat 194 may be integrally formed at a lower portion of the alignment member 170 (FIGS. 22 and 23) such that the second end 192 of the alignment member 170 and a second end 196 of the seat 194 cooperate to form a flat circular surface 197 (FIG. 22).

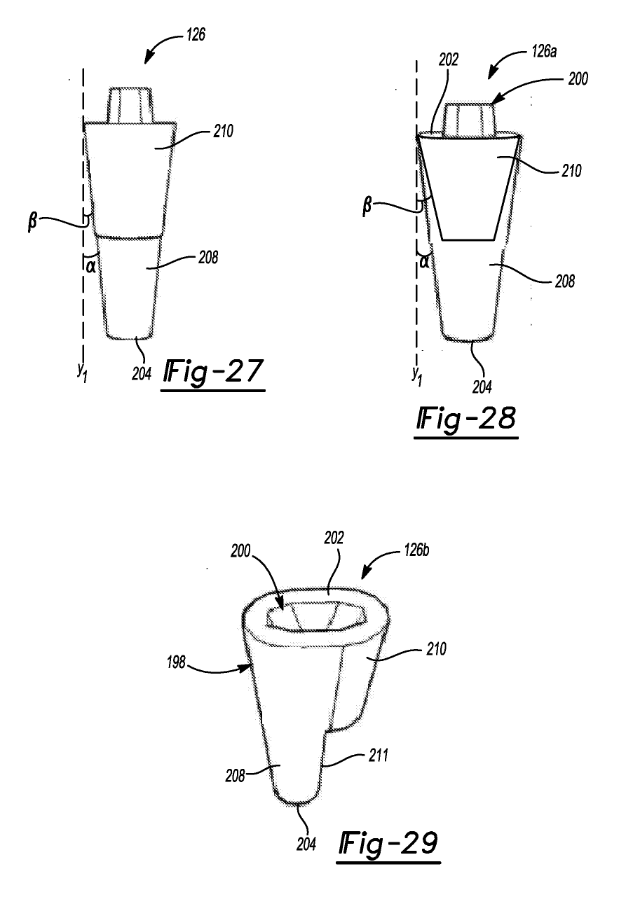

The dental implant 126 may be made out of a titanium alloy and/or covered with hydroxyl apatite or other biocompatible bone inducing material, for example, and installed into the cavity 128 formed by the drill assembly (composed of the first drill 22 and the second drill 134) and surgical guide 124. The dental implant 126 may include a body 198 and an attachment member/members or interlocking member 200 (FIGS. 24 and 25). The body 198 of the dental implant 126 may have a flat oval-shaped first surface or platform 202 and a flat circular-shaped second surface 204. It should be understood that the second surface 204 may be any suitable shape (e.g., oval, dome or torpedo, etc.) that allows for the convenient installation of the dental implant 126 into the cavity 128 formed in the jawbone 130. The body 198 may include an implant core portion 208 and an extension portion 210 attached at a side 211 of the implant core portion 208 (FIGS. 25 and 26). In some configurations, the body 198 may also include a plurality of apertures (not shown) extending there through. The plurality of apertures (not shown) may be filled with a hydroxyapatite and/or bone inducing or osteoconductive material to promote bone growth inside and between the dental implant 126 and the jawbone 130. In some configurations, a surface of the body 198 may have a roughness to increase the surface of the implant 126 in contact with the jawbone 130 and to facilitate or promote bone growth between the dental implant 126 and the jawbone 130.

The implant core portion 208 may extend from the flat oval-shaped first surface 202 to the flat circular-shaped second surface 204 at a first tapered angle α relative to a vertical axis Y1. The extension portion 210 may extend from the first surface 202 toward the third surface 212 such that a distance d is between the second surface 204 and the third surface 212 (FIG. 26). The extension portion 210 may also extend from the first surface 202 to the third surface 212 at a second tapered angle β relative to the vertical axis Y1. The first and second tapered angles α, β of the implant core portion 208 and the extension portion 210, respectively, may be equal to each other (FIG. 27). In some configurations, a dental implant may 126a have first and second tapered angles α, β that are different from one another (FIG. 28). This provides the advantage of avoiding a bone graft procedure, for example, when the jawbone 130 has varying thicknesses in adjacent areas, due to the ability of the implant core portion 208 and/or the extension portion 210 to account for such varying thicknesses.

The attachment member 200 may be single or double (not shown) and may be hexagonal shape and attached to the first surface 202 of the body 198 (FIG. 25). The attachment member 200 may be attached to the first surface 202 so as to extend outwardly therefrom. In some configurations, the attachment member 200 may extend inwardly from the first surface 202 of the body 198 of a dental implant 126b toward the second surface 204 (FIG. 29). It should be understood that the attachment member 200 may also be any other suitable shape (e.g., square, rectangle, pentagonal, etc.) that allows for attachment to the first surface 202 of the body 198. The attachment member 200 may include a plurality of apertures 214 (fastener holes) on the surface 216 to allow a prosthetic or superstructure (not shown) to be attached to dental implant 126. The abutment (not shown) may be similar in structure and function to the abutment 17, as described above.

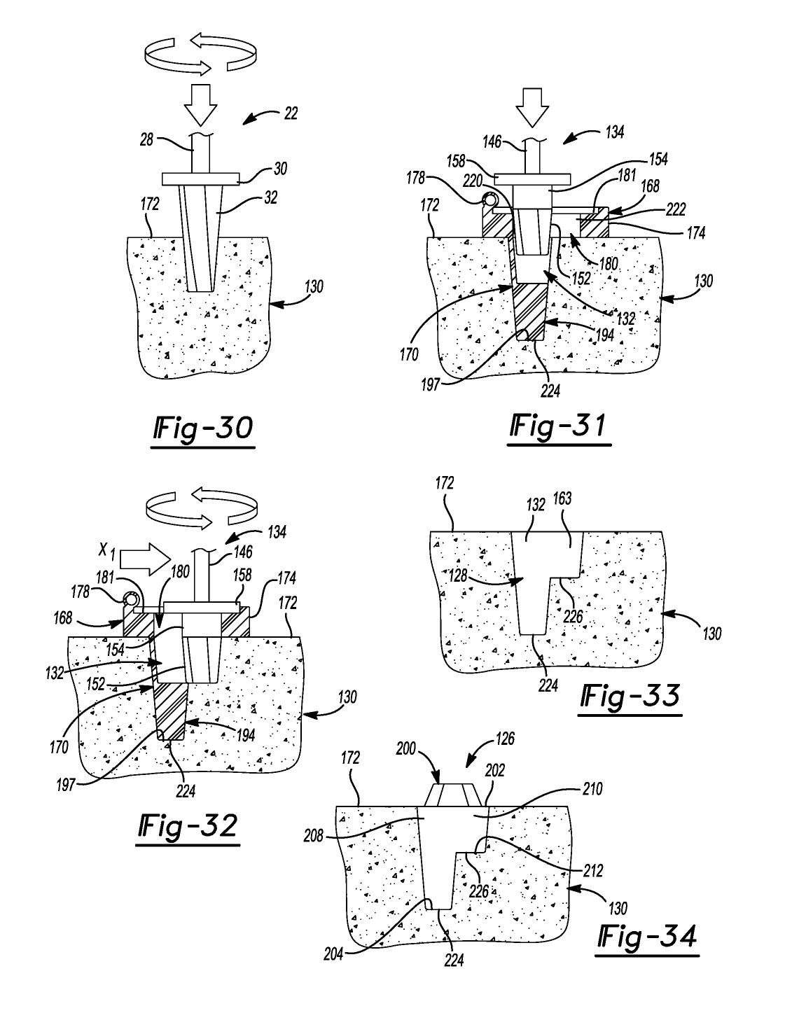

With continued reference to FIGS. 21-34, installation of the dental implant 126 will be described in detail. A user (not shown) forms the initial core 132 in the jawbone 130 of the patient (not shown) using the first drill 22 (FIG. 30).

The user then positions the seat portion 168 of the surgical guide 124 on the top surface 172 of the jawbone 130 such that the alignment member 170 extends into the initial core 132 formed by the first drill 22 and an outer surface of the alignment member 170 is adjacent to the jawbone 130 (FIGS. 31 and 32). The second drill 134 is inserted through a first end 220 of the opening 180 such that the drilling portion 152 extends through the first end 220 of the opening 180 into the initial core 132 and the guide member 147 is substantially co-planar with the body 174 of the seat portion 168. The alignment member 170 facilitates alignment of the drill portion 152 within the initial core 132 and the flange 158 traverses the recess 181 of the body 198 as the second drill 134 traverses in direction X1 from the first end 220 to a second end 222, thereby removing a portion of the jawbone 130 to form the extension to the core 163 of the cavity 128 (FIG. 32). The gripping elements 176 grip the jawbone 130 to facilitate stability of the surgical guide 124 relative to the jawbone 130 when the second drill 134 is traversing the opening 180. The tubular member 178 extending along the second end 188 of the seat portion 168 further facilitates stability of the surgical guide 124 relative to the jawbone 130 when the second drill 134 is traversing the opening 180.

The user then installs the dental implant 126 into the cavity 128 (FIG. 33) such that the implant core portion 208 of the dental implant 126 is disposed in the initial core 132 and the extension portion 210 of the dental implant 126 is disposed in the extension core 163 of the cavity 128 (FIG. 34). The second surface 204 of the body 198 abuts a bottom surface 224 of the cavity 128 and the third surface 212 of the body 198 abuts an intermediate surface 226 of the cavity 128. It should be understood that the dental implant 126 may include a collar (not shown) extending around a periphery of the first surface 97 toward the second and third surface.

With reference to FIG. 35-44, another group of the “OPI” dental implant 326 (Type II) is provided. The structure and function of the dental implant 326 may be similar or identical to that of the dental implants 16, 126, apart from any exceptions described below.

The dental implant 326 may be made of a titanium alloy and/or covered with hydroxyl apatite or other biocompatible bone inducing material, for example, and installed into a cavity 363 (FIG. 43) formed by the drill assembly (composed of the first drill 22 and the second drill 134) and surgical guide 124. The dental implant 326 may include a body 330 and an attachment member or interlocking member 332. The body 330 of the dental implant 326 may have a flat oval-shaped first surface 334 and may have a flat circular-shaped second surface 336. It should be understood that the second surface 336 may be any suitable shape (e.g., oval, dome or torpedo, etc.) that allows for the convenient installation of the dental implant 326 into the cavity 363 formed in a jawbone 340. The body 330 may include an implant core portion 342, a first extension portion 344 attached to one side 346 of the implant core portion 342, and a second extension portion 348 attached to another side 350 of the implant core portion 342. In some configurations, the body 330 may also include a plurality of apertures (not shown) extending therethrough. The plurality of apertures (not shown) may be filled with a hydroxyapatite and/or bone inducing or osteoconductive material to promote bone growth inside and between the dental implant 326 and the jawbone 340. In some configurations, the surface of the implant body 330 may have a roughness to increase the surface of the implant 326 in contact with the jawbone 340 and to facilitate or promote bone growth between the dental implant 326 and the jawbone 340.

The implant core portion 342 may extend from the first surface 334 to the second surface 336 at a first tapered angle α relative to a vertical axis Y1. The first extension portion 344 may extend from the first surface 334 toward the third surface 356 of the body 330 such that a distance d1 is between the second surface 336 and the third surface 356 (FIG. 36). The first extension portion 344 may also extend from the first surface 334 to the third surface 356 at a second tapered angle β relative to the vertical axis Y1. The first and second tapered angles α, β of the implant core portion 342 and the first extension portion 344, respectively, may be equal to each other (FIG. 37). In some configurations, the first and second tapered angles α, β may be different from one another. This provides the advantage of avoiding a bone graft procedure, for example, when the jawbone 340 has varying thicknesses in adjacent areas due to the ability of the implant core portion 342 and/or the first extension portion 344 to account for such varying thicknesses.

The second extension portion 348 may extend from the first surface 334 toward the fourth surface 358 of the body 330 such that a distance d2 is between the second surface 336 and the fourth surface 358 (FIG. 36). The distance d2 may be equal to or different than the distance d1. The second extension portion 348 may also extend from the first surface 334 to the fourth surface 358 at a third tapered angle relative to the vertical axis Y2. The first and third tapered angles α, φ of the implant core portion 342 and the second extension portion 348, respectively, may be equal to each other (FIG. 38). In some configurations, the first and third tapered angles α φ may be different from one another. This provides the advantage of avoiding a bone graft procedure, for example, when the jawbone 340 has varying thicknesses in adjacent areas due to the ability of the implant core portion 342 and/or the second extension portion 348 to account for such varying thicknesses. It should also be understood that the first, second, and third tapered angles α, β, φ may be equal to or different with respect to one another.

The attachment member 332 may be a single piece construction as shown or a multi-piece construction, such as a double piece construction, for example, and may be hexagonal shape and attached to the first surface 334 of the implant body 330. The attachment member 332 is attached to the first surface 334 so as to extend outwardly therefrom. In some configurations, the attachment member 332 may extend inwardly from the first surface 334 of the body 330 toward the second surface 336. It should be understood that the attachment member 332 may also be any other suitable shape (e.g., square, rectangle, pentagonal, etc.) that allows for attachment on the first surface 334 of the implant body 330 connect to the prosthetic element or superstructures. The attachment member 332 include a plurality of apertures screw holes on the surface to allow a prosthetic (not shown) to be attached to the dental implant 326.

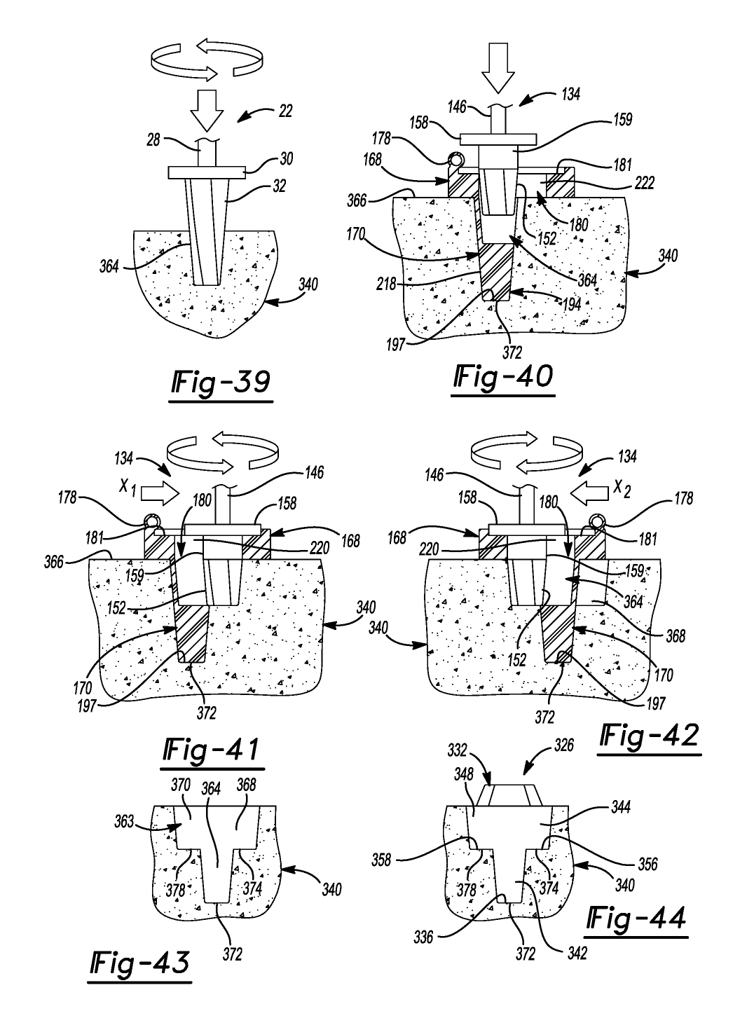

Within continued reference to FIGS. 35-44, installation of the dental implant 326 into a cavity 363 will be described in detail. A user (not shown) forms an initial core 364 in the jawbone 340 of a patient (not shown) using the first drill 22 (FIG. 39).

The user then positions the seat portion 168 of the surgical guide 124 on a top surface 366 of the jawbone 340 such that the alignment member 170 extends into the initial core 364 formed by the first drill 22 and the outer surface (not shown) of the alignment member 170 is adjacent to the jawbone 340 (FIGS. 40 and 41). The second drill 134 is inserted through the first end 220 of the opening 180 such that the drilling portion 152 extends through the first end 220 of the opening 180 into the initial core 364. The flange 158 traverses the recess 181 as the second drill 134 traverses in direction X1 from the first end 220 to the second end 222, thereby removing a portion of the jawbone 340 to form a first extension to the core 368 of the cavity 363 (FIG. 41). The gripping elements 176 grip the jawbone 340 to facilitate stability of the surgical guide 124 relative to the jawbone 340 when the second drill 134 is traversing the opening 180. The tubular member 178 extending along the second end 188 of the seat portion 168 further facilitates stability of the surgical guide 124 relative to the jawbone 340 when the second drill 134 is traversing the opening 180.

The surgical guide 124 is then removed, rotated 180 degrees and repositioned on the jawbone 340 such that the alignment member 170 extends into the initial core 364 from the opposite direction (FIG. 42). The second drill 134 is re-inserted through the first end 220 of the opening 180 such that the drilling portion 152 extends through the first end 220 of the opening 180 into the initial core 364 and the flange 158 traverses the recess 181 as the second drill 134 traverses in direction X2 from the first end 220 to the second end 222, thereby removing another portion of the jawbone 340 to form a second extension core 370 (FIG. 42).

The user then installs the dental implant 326 into the cavity such that the implant core portion 342 of the dental implant 326 is disposed in the initial core 364, the first extension portion 344 of the dental implant 326 is disposed in the first extension core 368 and the second extension portion 348 of the dental implant 326 is disposed in the second extension core 370 (FIGS. 43 and 44). The second surface 336 of the body 330 abuts a bottom surface 372 of the cavity 363, the third surface 356 of the body 330 abuts a first intermediate surface 374 of the cavity 363, and the fourth surface 358 of the body 330 abuts a second intermediate surface 378 of the cavity 363 (FIG. 44).

It should be understood that the dental implant 326 may include a collar (not shown) extending around a periphery of the first surface 334 toward the second, third and fourth surface of the implant body.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A dental implant comprising:
a body having an implant core portion and an extension portion, the implant core portion extending from a first surface of the body to a second surface of the body at a first tapered angle, the extension portion extending from the first surface of the body to the second surface of the body at a second tapered angle; and
an attachment member attached to the first surface of the body, the attachment member configured to attach a prosthetic to the body.

2. The dental implant of claim 1, wherein the attachment member extends outwardly from the first surface of the body.

3. The dental implant of claim 1, wherein the attachment member extends inwardly toward the second surface from the first surface of the body.

4. The dental implant of claim 1, wherein a plurality of apertures extend through the body of the dental implant.

5. The dental implant of claim 1, wherein the first tapered angle and the second tapered angle are the same.

6. The dental implant of claim 1, wherein the first tapered angle and the second tapered angle are different.

7. The dental implant of claim 1, wherein the attachment member is elongated.

8. The dental implant of claim 2, wherein the attachment member has a shape selected from an oval or polygonal.

9. The dental implant of claim 8, wherein said attachment member is tapering.

10. The dental implant of claim 1, wherein the attachment member is configured to attach to a prosthetic via an abutment.

11. The dental implant of claim 10, wherein the abutment includes either a recess or an extension that mates with a corresponding portion of the attachment member.

12. The dental implant of claim 11, wherein the mating portions of the attachment member and the abutment are elongated.

13. A dental implant comprising:
a body having an implant core portion and a first extension portion attached to a first side of the implant core portion, the implant core portion extending from a first surface of the body to a second surface of the body, the first extension portion attached to one side of the implant core portion and extending from the first surface of the body toward the third surface of the body, the second surface and the third surface having a first distance between each other; and
an attachment member attached to the first surface of the body, the attachment member configured to attach a prosthetic to the body.

14. The dental implant of claim 13, wherein a plurality of apertures extend through the body of the dental implant.

15. The dental implant of claim 13, wherein the implant core portion extends from the first surface to the second surface at a first tapered angle and the first extension portion extends from the first surface to the third surface of the body at a second tapered angle.

16. The dental implant of claim 13, wherein the first tapered angle and the second tapered angle are the same.

17. The dental implant of claim 13, wherein the first tapered angle and the second tapered angle are different.

18. The dental implant of claim 13, wherein the body includes a second extension portion attached to another side of the implant core portion and extending from the first surface toward the fourth surface, and wherein the second surface and the fourth surface have a second distance between each other.

19. The dental implant of claim 18, wherein the first distance and the second distance are the same.

20. The dental implant of claim 18, wherein the first distance and the second distance are different.

21. The dental implant of claim 18, wherein the second extension portion extends from the first surface to the fourth surface at a third tapered angle, and wherein the first tapered angle and the third tapered angle are different.

22. The dental implant of claim 13, wherein the attachment member is configured to attach to a prosthetic via an abutment.

23. The dental implant of claim 22, wherein the abutment includes either a recess or an extension that mates with a corresponding portion of the attachment member.
